(19) United States
(12) Patent Application Publication
(10) Pub. No.: US 2021/0208832 A1
(43) Pub. Date: Jul. 8, 2021

(54) IMAGE DISPLAY DEVICE AND IMAGE TRANSMISSION METHOD

(71) Applicant: Sharp NEC Display Solutions, Ltd., Tokyo (JP)

(72) Inventor: Eisaku ISHII, Tokyo (JP)

(21) Appl. No.: 17/203,322

(22) Filed: Mar. 16, 2021

Related U.S. Application Data
(63) Continuation of application No. PCT/JP2018/040834, filed on Nov. 2, 2018.

(51) Int. Cl. G06F 3/14; H04N 19/146

(52) U.S. Cl. CPC G06F 3/1431; G06F 3/1454; H04N 19/146

(57) ABSTRACT

An image display device that transmits a display image displayed on a display screen to a terminal device includes a data processing device configured to stop transmission of a display image to the terminal device if a change amount of the display screen exceeds a first threshold value.

### TECHNICAL FIELD

The present invention relates to an image display device and an image transmission method.

### BACKGROUND ART

Patent Literature 1 below discloses an image display system that displays materials of a presenter on an image display device such as a projector in a presentation, a conference, or the like.

Incidentally, if a presentation or a conference is held in a relatively large conference room, there is a desire to display the materials (a display image) of the presenter displayed on the image display device on each terminal device in the hands of participants via a network and for reference.

### CITATION LIST

### Patent Literature

### Patent Literature 1

Japanese Unexamined Patent Application, First Publication No. 2010-206618

### SUMMARY OF INVENTION

### Technical Problem

However, as the number of participants increases, a heavier load is applied to a network if a display image is transmitted to each terminal device via the network, which causes a problem that a significant delay occurs.

The present invention has been made in view of such circumstances, and an object thereof is to curb a delay of a display on a terminal device if a display image of an image display device is displayed on the terminal device.

### Solution to Problem

According to an aspect of the present invention, an image display device that transmits a display image displayed on a display screen to a terminal device is an image display device that includes a data processing device configured to stop transmission of a display image to the terminal device if a change amount of the display screen exceeds a first threshold value.

According to another aspect of the present invention, an image transmission method for transmitting a display image displayed on a display screen of an image display device to a terminal device from the image display device is an image transmission method that includes a control step of the image display device stopping transmission of a display image to the terminal device if it is determined that the change amount of the display screen exceeds a first threshold value.

### Advantageous Effects of Invention

As described above, according to the present invention, it is possible to curb a delay of a display on a terminal device if a display image of an image display device is displayed on the terminal device.

### BRIEF DESCRIPTION OF DRAWINGS

FIG. 1 is a diagram which shows an example of a schematic configuration of an image transmission system A including an image display device 1 according to one embodiment of the present invention.

FIG. 2 is a diagram which shows a screen change amount according to the embodiment of the present invention.

FIG. 3 shows an example of a state in which amounts of changes in a screen shown in FIG. 2 according to the embodiment of the present invention are arranged in chronological order.

FIG. 4 is a diagram which describes an operation of an image display device 1 according to the embodiment of the present invention.

FIG. 5 is a diagram which describes operations of the image display device 1 and terminal devices 2 if a display image is transmitted from the image display device 1 to a plurality of terminal devices 2 according to the embodiment of the present invention.

FIG. 6 is a diagram which shows a method of transmitting image data for one screen from the image display device 1 according to the embodiment of the present invention to the plurality of terminal devices 2 via a route of a network W.

FIG. 7 is a diagram which describes a main configuration of the image display device 1 according to the embodiment of the present invention.

### DESCRIPTION OF EMBODIMENTS

Hereinafter, an image display device and an image transmission method according to an embodiment of the present invention will be described with reference to the drawings.

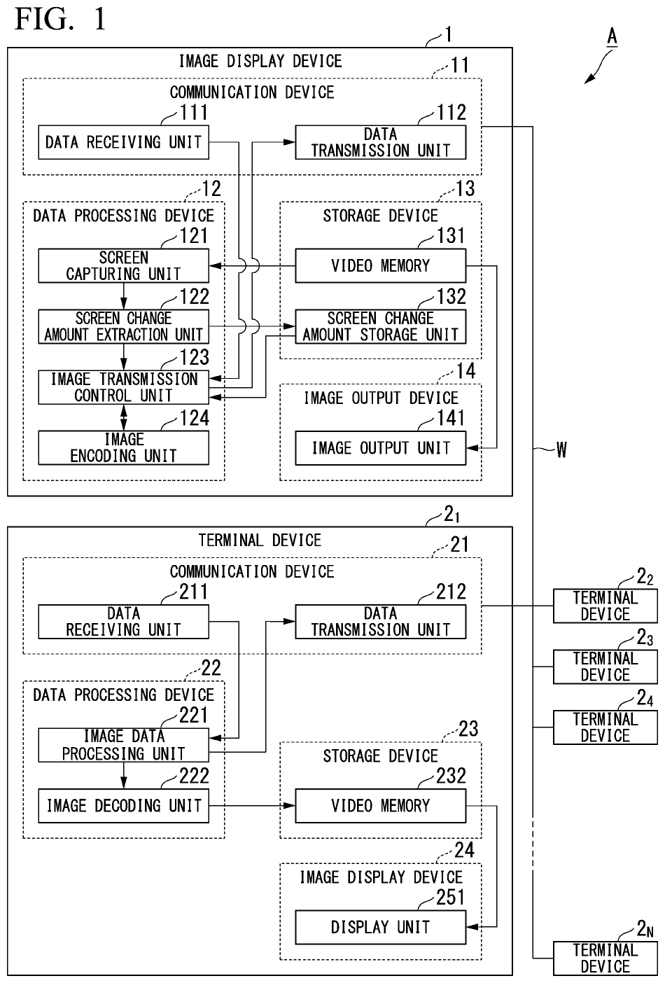

FIG. 1 is a diagram which shows an example of a schematic configuration of an image transmission system A including an image display device 1 according to one embodiment of the present invention.

The image transmission system A according to an embodiment of the present invention includes the image display device 1 and a plurality of terminal devices 2₁ to 2_{N}. The image transmission system A is a system that has an image transmission method of controlling a timing at which image transmission is started and an update interval of the image transmission in consideration of an update frequency (an update speed and an update area) of an image displayed on the image display device 1 if the image displayed on the image display device 1 is transmitted to the plurality of terminal devices 2₁ to 2_{N} connected via a network W.

The image display device 1 is connected to the plurality of terminal devices 2₁ to 2_{N} via the network W, and the image displayed on the image display device 1 is transmitted to the plurality of terminal devices 2₁ to 2_{N} via the network W. For example, the image display device 1 is a projector or a display. In addition, for example, the terminal devices 2₁ to 2_{N} are personal computers (PCs), smart devices, and the like.

The schematic configuration of the image display device 1 according to the embodiment of the present invention will be described below.

The image display device 1 includes a communication device 11, a data processing device 12, a storage device 13, and an image output device 14.

The communication device 11 is connected to a plurality of terminal devices 2₁ to 2_{N} by a network W and transmits or receives information to or from the plurality of terminal devices 2₁ to 2_{N} (N is an integer of 2 or more).

The communication device 11 includes a data receiving unit 111 and a data transmission unit 112.

The data receiving unit 111 receives connections from each of the plurality of terminal devices 2₁ to 2_{N} and acquires information.

The data transmission unit 112 transmits a display image displayed on the display screen of the image output device 14 to each of the plurality of terminal devices 2₁ to 2_{N}.

The data processing device 12 includes a screen capturing unit 121, a screen change amount extraction unit 122, an image transmission control unit 123, and an image encoding unit 124. The data processing device 12 may be configured of a microprocessor such as a CPU or an MPU, a microcontroller such as an MCU, or the like.

The screen capturing unit 121 acquires the display image displayed on the display screen of the image output device 14 by performing screen capturing on the screen of the image output device 14 on a regular basis according to a screen capturing cycle T_{C}. The screen capturing unit 121 transmits the display image (hereinafter referred to as a “captured screen”) obtained by the screen capturing to the screen change amount extraction unit 122.

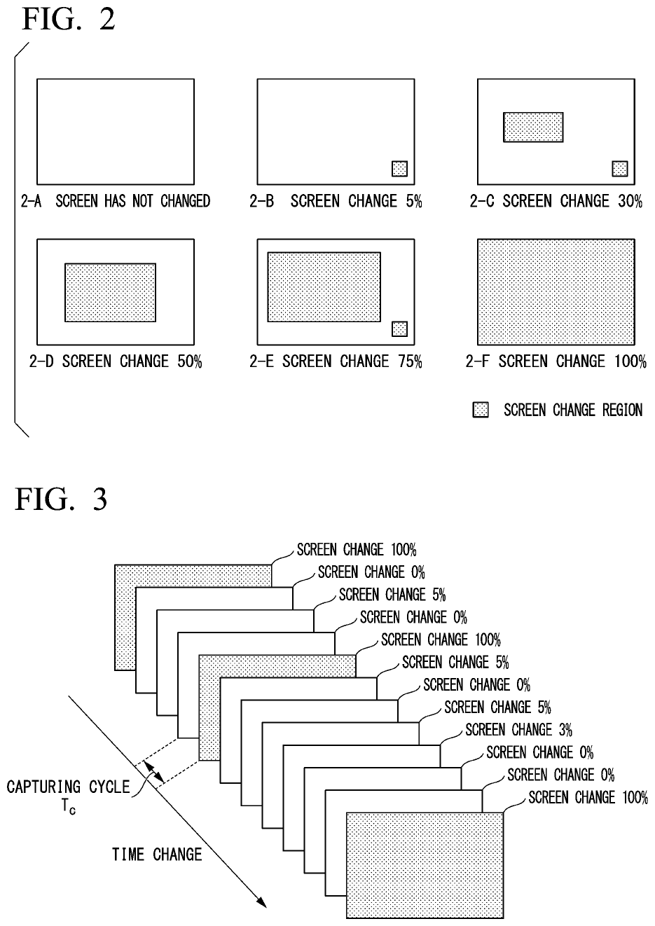

The screen change amount extraction unit 122 extracts a difference between previous and next captured screens among captured screens transmitted from the screen capturing unit 121 as a screen change amount on a regular basis. FIG. 2 is a diagram which shows the screen change amount according to the embodiment of the present invention. In FIG. 2, a case of 2-A indicates that the screen has not changed at all. A case of 2-B indicates a case in which there is a screen change of 5% as a local area. Next, similarly, cases of 2-C, 2-D, and 2-E indicate that there are screen changes of 30%, 50%, and 75%, respectively, and a case of 2-F indicates that an entirety of a previous screen changes.

For example, the screen change amount extraction unit 122 determines in units of pixels whether a current captured screen has changed from a previous captured screen, and extracts how much the captured screen has changed as a whole from the previous captured screen (a difference between the previous and current captured screens) as a screen change amount. Therefore, in the example shown in FIG. 2, the screen change amount extraction unit 122 sets the difference between the previous and current captured screens as a screen change amount=0% in the case of 2-A, a screen change amount=5% in the case of 2-B, a screen change amount=30% in the case of 2-C, a screen change amount=50% in the case of 2-D, a screen change amount=75% in the case of 2-E, and a screen change amount=100% in the case of 2-F.

The screen change amount extraction unit 122 extracts the screen change amount for each screen capturing transmitted from the screen capturing unit 121. For this reason, the screen change amount extraction unit 122 obtains the screen change amount for each screen capturing cycle T_{C} as shown in FIG. 3. FIG. 3 shows an example of a state in which amounts of changes in a screen shown in FIG. 2 are arranged in chronological order. At this time, an interval of each screen capturing is represented by a capturing cycle Tc.

The screen change amount extraction unit 122 stores the extracted screen change amount in the storage device 13 in chronological order.

The image transmission control unit 123 controls the transmission of the display image G (for example, a captured screen) from the data transmission unit 112 to the plurality of terminal devices 2₁ to 2_{N} according to the screen change amount.

More specifically, the image transmission control unit 123 determines whether the screen change amount is equal to or less than a predetermined threshold value R_{S} if the display image G is currently not transmitted from the data transmission unit 112 to the plurality of terminal devices 2₁ to 2_{N}. Then, if the screen change amount is determined not to be equal to or less than the threshold value R_{S} (if it exceeds the threshold value R_{S}), the image transmission control unit 123 determines that the change in a display screen in the image output device 14 is large, and performs control such that the transmission of the display image G from the data transmission unit 112 to the plurality of terminal devices 2₁ to 2_{N} is not performed. As a result, a large load is prevented from being applied to the network W. The threshold value R_{S} indicates an amount of change with which the display image G can be transmitted.

If the screen change amount is equal to or less than the threshold value R_{S}, the image transmission control unit 123 starts the transmission of the display image G from the data transmission unit 112 to the plurality of terminal devices 2₁ to 2_{N}.

Furthermore, the image transmission control unit 123 determines whether a current screen change amount extracted by the screen change amount extraction unit 122 is equal to or less than the threshold value R_{T} if the display image G is transmitted from the data transmission unit 112 to the plurality of terminal devices 2₁ to 2_{N}. Then, the image transmission control unit 123 determines that the change in a display screen in the image output device 14 is large, and stops the transmission of the display image G from the data transmission unit 112 to the plurality of terminal devices 2₁ to 2_{N} if the current screen change amount is not equal to or less than the threshold value R_{T}. As a result, a large load is prevented from being applied to the network W. The threshold value R_{T} is a threshold value of the amount of change with which image transmission can continue.

For example, the threshold value R_{S} is a value smaller than the threshold value R_{T}.

The threshold value Rₛ and the threshold value R_{T} may be constants (fixed values) or variables (variable values). For example, if the number of terminal devices 2 connected to the communication device 11 via the network W (hereinafter, “the number of connections”) N is large, if the threshold value R_{T} is decreased, the transmission of the display image G to a plurality of terminal devices 21 to 2N (hereinafter, simply referred to as “image transmission”) becomes easier to stop. Therefore, the image display device 1 (for example, a data processing device) may calculate the number of connections N by measuring the number of terminal devices that can communicate with via the network W, and set the threshold value R_{T} according to the calculated number of connections N. For example, the image display device 1 (for example, the data processing device) may also set a value of the threshold value R_{T} to decrease continuously or discontinuously as the number of connections N increases. Furthermore, for example, the image display device 1 (for example, the data processing device) may change the value of the threshold value R_{T} from the first value to the second value if the number of connections N exceeds a threshold value Nₜₕ. In this case, the second value is a value smaller than the first value. That is, the image display device 1 (for example, the data processing device) sets the first value to the threshold value R_{T} if the number of connections N is equal to or less than the threshold value Nₜₕ, and sets the second value to the threshold value R_{T} if the number of connections N exceeds the threshold value Nₜₕ.

On the other hand, for the threshold value R_{S}, as the threshold value Rₛ becomes smaller, it is more difficult to start image transmission. For example, if a moving image is displayed on a part of a display screen, if the threshold value R_{S} is set to be too small, image transmission may not be started. For this reason, the image display device 1 (for example, the data processing device) may perform control to increase a value of the current threshold value R_{S} if the moving image is displayed on a part of the display screen. For example, if a moving image is included in at least a part of the display image G, the image display device 1 (for example, the data processing device) may set the threshold value R_{S} to a higher value as compared to if a moving image is not included in the display image G. That is, the threshold value R_{S} used if a moving image is included in at least a part of the display image G is set to a value higher than the threshold value R_{S} used if a moving image is not included in the display image G. In this manner, the image display device 1 (for example, the data processing device) may change the value of the current threshold value R_{S} according to a type of the display image G displayed on the display screen. The type of the display image G may be a type classified according to an image file format as well as a classification such as a still image or a moving image. Moreover, the image display device 1 (for example, the data processing device) may change the value of the current threshold value R_{S} according to a size of the display image G displayed on the display screen.

Here, the threshold R_{T} is an example of the “first threshold” of the present invention. The threshold R_{S} is an example of the “second threshold” of the present invention

The image encoding unit 124 compresses an image of a current display screen and transmits it to the data transmission unit 112.

The storage device 13 includes a video memory 131 and a screen change amount storage unit 132.

The video memory 131 stores image data or the like of the display image G displayed on the display screen of the image output device 14. Therefore, screen capturing by the screen capturing unit 121 of the present embodiment involves acquiring the image data of the display image G displayed on the display screen of the image output device 14 from the video memory 131.

The screen change amount storage unit 132 stores a screen change amount extracted by the screen change amount extraction unit 122.

The image output device 14 includes an image output unit 141. The image output unit 141 includes, for example, a display screen such as an LCD or an electroluminescence (EL) panel, and outputs the image data stored in the video memory 131 to the display screen to display the image on the display screen.

Each of the plurality of terminal devices 2₁ to 2_{N} has the same configuration. If the plurality of terminal devices 2₁ to 2_{N} are not distinguished, they are simply indicated as a “terminal device 2.”

The schematic configuration of the terminal devices 2 according to the embodiment of the present invention will be described below.

The terminal devices 2 include a communication device 21, a data processing device 22, a storage device 23, and an image display device 24.

The communication device 21 is connected to the image display device 1 by the network W, and transmits or receives information to or from the image display device 1. The communication device 21 includes a data receiving unit 211 and a data transmission unit 212.

The data receiving unit 211 receives the display image G from the data transmission unit 112 of the image display device 1. Then, the data receiving unit 211 transmits the display image G received from the image display device 1 to the data processing device 22.

The data transmission unit 212 transmits information to the image display device 1 and a terminal device 2 other than a host device.

The data processing device 22 includes an image data processing unit 221 and an image decoding unit 222.

The image data processing unit 221 acquires the display image G compressed in the image display device 1 from the image display device 1 via the data receiving unit 211, and transmits the acquired display image G to the image decoding unit 222.

The image decoding unit 222 restores the display image G transmitted from the image data processing unit 221 to return it to its original state, and stores it in the storage device 23.

The storage device 23 includes a video memory 231. The video memory 231 stores the display image restored by the image decoding unit 222.

The image display device 24 includes a display unit 251.

This display unit 251 displays the display image G stored in the video memory 231 on a display screen. This display screen is an LCD, an EL panel, or the like.

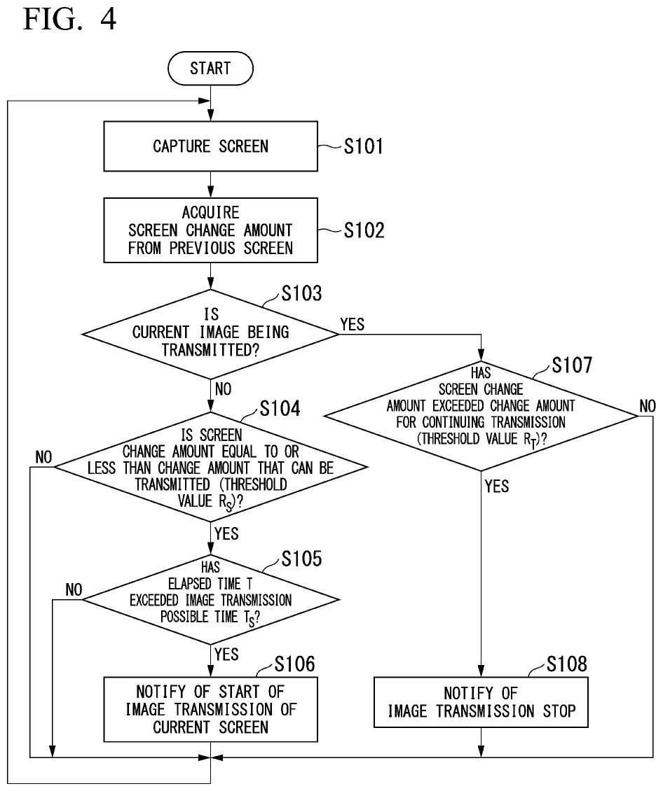

An image transmission method according to the embodiment of the present invention will be described below using FIG. 4. FIG. 4 is a diagram which describes an operation of the image display device 1 according to the embodiment of the present invention.

If the communication device 11 accepts connections from the plurality of terminal devices 2₁ to 2_{N}, the screen capturing unit 121 performs screen capturing from the video memory 131 according to the screen capturing cycle T_{C} on a regular basis (step S101). Next, the screen change amount extraction unit 122 determines whether there is a difference between a captured screen of one previous screen (hereinafter referred to as a “captured screen of a previous screen”) and a current captured screen, and if there is a difference, extracts the difference as a screen change amount from the previous screen (step S102). In the present embodiment, the screen change amount indicates a ratio of a change in the captured screen of the previous screen to an entire captured screen. The screen change amount extraction unit 122 stores the extracted screen change amount in the screen change amount storage unit 132.

Next, the image transmission control unit 123 determines whether a current display image G is being transmitted from the data transmission unit 112 to the plurality of terminal devices 2₁ to 2_{N} (step S103). The image transmission control unit 123 determines whether the screen change amount extracted by the screen change amount extraction unit 122 is equal to or less than a threshold value R_{S} (step S104) if the current display image G is not being transmitted to the plurality of terminal devices 2₁ to 2_{N} (hereinafter referred to as “image transmission in progress”).

The image transmission control unit 123 determines whether an elapsed time T since a last image transmission was stopped has passed a specified image transmission possible time T_{S} (step S105) if it is determined that the screen change amount extracted by the screen change amount extraction unit 122 is equal to or less than the threshold value R_{S}. The elapsed time T since the last image transmission was stopped is an elapsed time since the image transmission was stopped in step S108 to be described below, or an elapsed time since YES was determined in step S107.

The image transmission possible time T_{S} is at least larger than a time interval for capturing a screen, that is, the screen capturing cycle T_{C}. For example, the screen capturing cycle T_{C} is set to 1/30 seconds, and the image transmission possible time T_{S} is set to 0.5 seconds. Moreover, a maximum transmission interval, which is a maximum value of the image transmission possible time T_{S}, may be set to, for example, 5 seconds. Furthermore, the image transmission possible time T_{S} may be a constant or a variable. For example, if the number of connections N is large, the image transmission control unit 123 may cause a restart of the stopped image transmission to be delayed by increasing the image transmission possible time T_{S}. As a result, a load on a network of an entire system can be reduced.

In step S105, if it is determined that the elapsed time T has passed the image transmission possible time T_{S} (the elapsed time T exceeds the image transmission possible time T_{S}), the image transmission control unit 123 causes a current display screen to be image-compressed by the image encoding unit 124, and at the same time, notifies the plurality of terminal devices 2₁ to 2_{N} of a start (hereinafter referred to as “image transmission start”) of transmission of the current display screen, that is, the display screen whose image is compressed by the image encoding unit 124, via the data transmission unit 112 (step S106). Note that the image transmission control unit 123 returns to processing of performing next screen capturing (step S101) without notifying the plurality of terminal devices 2₁ to 2_{N} of the start of image transmission if it is determined in step S104 and step S105 that respective conditions are not satisfied.

In addition, in step S103, if it is determined that image transmission is in progress, the image transmission control unit 123 determines whether the screen change amount exceeds a threshold value R_{T} (step S107), and notifies the plurality of terminal devices 2₁ to 2_{N} that the transmission of the display image G from the data transmission unit 112 to the plurality of terminal devices 2₁ to 2_{N} is stopped (hereinafter referred to as “image transmission stop”) if the screen change amount exceeds the threshold value R_{T} (step S108). At this time, the plurality of terminal devices 2₁ to 2_{N} do not receive data for one screen as a display screen until the end, but can operate normally as if nothing had happened by discarding previous screen data if a packet of next one screen data is sent.

The image transmission control unit 123 starts clocking of the elapsed time T if the image transmission stop is notified of or if the transmission of the display image G to the plurality of terminal devices 2₁ to 2_{N} is stopped. However, a timing for the clocking of the elapsed time T is not limited thereto, and the image transmission control unit 123 may start the clocking of the elapsed time T if it is determined in the processing of step S107 that the screen change amount exceeds the threshold value R_{T}.

In step S107, the image transmission control unit 123 causes the transmission of the display image G from the data transmission unit 112 to the plurality of terminal devices 2₁ to 2_{N} to continue if the screen change amount does not exceed the threshold R_{T}. Then, the procedure returns to the processing of step S101, and it is determined whether the image transmission to the plurality of terminal devices 2₁ to 2_{N} is performed at an interval of the capture cycle T_{C}, and the processing shown in FIG. 4 is continued.

Note that the notification of a start of image transmission in step S106 and the notification of a stop of image transmission in step S108 of FIG. 4 are not essential configurations of the present invention.

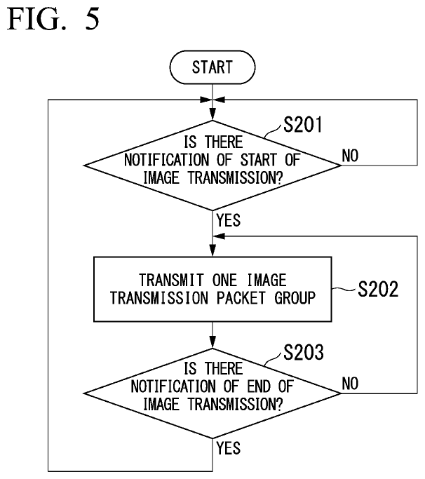

Next, operations of the image display device 1 and the terminal devices 2 if the display image G is transmitted from the image display device 1 according to the embodiment of the present invention to the plurality of terminal devices 2 will be described. FIG. 5 is a diagram which describes the operations of the image display device 1 and the terminal devices 2 if the display image G is transmitted from the image display device 1 according to the embodiment of the present invention to the plurality of terminal devices 2.

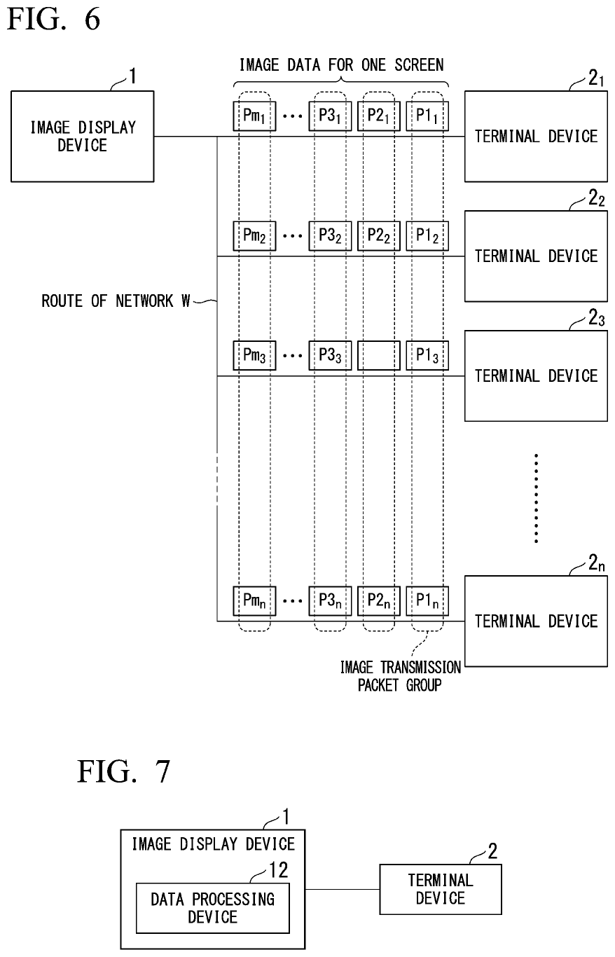

If the communication device 21 of the terminal device 2 receives the notification of a start of image transmission of a current display screen (step S201), the image display device 1 (the data transmission unit 112) transmits image data for one current screen whose image is compressed by the image encoding unit 124 to the terminal devices 2₁ to 2_{N} via the network W (step S202). For example, as shown in FIG. 6, the image display device 1 divides data for one screen into a plurality of packets and transmits the data in units of image transmission packet groups to each of the terminal devices 2₁ to 2_{N} in chronological order such that the transmission can be stopped at any time if the data for one screen is being transmitted. However, the present invention is not limited thereto, and the image data for one screen transmitted from the image display device 1 to each of the terminal devices 2₁ to 2_{N} may be data of all of a current screen (whole screen), and may also be data of only a difference between a screen whose image is successfully transmitted to the end in a previous image transmission and a screen whose image is currently being transmitted.

Then, the processing of transmitting one image transmission packet group from the image display device 1 to the terminal devices 2₁ to 2_{N} is continuously repeated until the terminal devices 2₁ to 2_{N} receive the notification of a stop of image transmission (step S203).

As described above, if the screen change amount of a display screen is larger than the threshold value R_{T}, the image display device 1 can prevent a large load from being applied to the network W by not transmitting the display image G to each of the terminal devices 2₁ to 2_{N}.

Here, an effect of the image display device 1 according to the present embodiment will be described.

If the image display device 1 and the plurality of terminal devices 2₁ to 2_{N} are connected via the network W at a ratio of 1:N, and an image is transmitted as a continuous still image, a first method in which the image display device 1 captures an image of a screen of the image display device 1 with a constant cycle T (an interval for several seconds) and transmits the image to the terminal device 2, or a second method in which the image display device 1 captures an image of a screen of the image display device with a short cycle (for example, an interval of several tens of ms) and transmits only a changed region to the terminal device 2 are considered as a method of reducing a load of a band used by the network W.

However, since a time required for the image transmission increases proportionally as the number of connected devices N increases in the first method, the cycle T for capturing an image of the screen of the image display device 1 and transmitting the image to terminal device 2 needs to be increased. As a result, it is difficult to display the image displayed on the image display device 1, for example, a screen of materials presented by the presenter, on each terminal device 2 at an appropriate timing.

Also, since image transmission to the terminal device 2 is frequently performed with a short cycle in the second method, an animation effect of the materials presented by the presenter becomes a trigger for image transmission. For this reason, it is difficult to display the screen of the materials presented by the presenter on the terminal device 2 at an appropriate timing.

On the other hand, the image display device 1 according to the present embodiment captures an image of the screen of the image display device with a short cycle (an interval of several tens of ms), monitors the screen change amount of each frame interval, and does not transmit the image if a screen change is large at a short interval. In addition, the image display device 1 starts to transmit the image if the screen change at a certain interval is equal to or less than the threshold value R_{S}, but immediately stops image transmission and discards an image that is currently being transmitted if the screen change at a short interval becomes large (if the screen change amount exceeds the threshold value R_{T}) even while the image is being transmitted. In this manner, the image display device 1 curbs the transmission of an image all the time if the screen change is large, and thereby transmits only an image displayed on the image display device 1 at a certain interval to a number of terminal devices 2. Therefore, it is possible to reduce the load on the network W and reduce a delay of the display of the terminal devices 2.

Next, a main configuration of the image display device 1 according to the embodiment of the present invention will be described.

FIG. 7 is a diagram which describes the main configuration of the image display device 1 according to the embodiment of the present invention.

As shown in FIG. 7, the image display device 1 includes a data processing device 12.

The data processing device 12 stops the transmission of the display image G to the plurality of terminal devices 2₁ to 2_{N} if the screen change amount of a display screen exceeds the threshold value R_{T} (a first threshold value). As a result, if the display image G of the image display device 1 is displayed on the terminal device 2 via the network W, it is possible to prevent a large load from being applied to the network W. For this reason, it is possible to curb the delay of the display on the terminal device 2.

Moreover, the data processing device 12 may start the transmission of the display image G to the terminal device 2 if the screen change amount of a display screen is equal to or less than the threshold value R_{S} (a second threshold value).

With such a configuration, it is possible to realize the display of the display image G on the terminal device 2 while curbing the delay of the display on the terminal device 2.

Here, for example, if the presentation materials (a display screen) of a presenter displayed on the image display device are switched in a presentation or conference, and if the screen change amount is large, there is a problem that a screen that the presenter does not intend may be displayed on the terminal devices of participants.

The image display device 1 of the present embodiment does not transmit the display image G to the terminal device 2 if the screen change amount of a display screen exceeds the threshold value R_{S}. For this reason, it is possible to prevent the screen that the presenter does not intend from being displayed on the terminal devices 2 of the participants.

Moreover, the data processing device 12 may start the transmission of the display image G to the terminal device 2 if the screen change amount of a display screen is equal to or less than the threshold value R_{S}, and may stop the transmission of the display image G to the terminal device 2 if the screen change amount exceeds the threshold value R_{T} even if the display image G is transmitted to the terminal device 2.

With such a configuration, the delay of the display screen between the image display device 1 and the terminal device 2 can be reduced even during image transmission, and a screen intended by the presenter (for example, a screen described by the presenter) can be displayed on the terminal device 2.

In addition, in the embodiment described above, a case in which a display region of an image of the image display device 1 is one screen has been described as an example, but the present invention is not limited thereto. For example, the display region of the image display device 1 may be divided into a plurality of screens such as two screens and four screens, and displays an image. In this case, this method (an image transmission method according to the present embodiment) may be applied to a plurality of screens independently for each divided region.

For example, if the plurality of divided images are displayed on one image display device 1, the image display device 1 performs screen capturing for each divided screen region and determines whether the screen change amount of a display screen exceeds the threshold value Rs for each divided screen region. Then, the image display device 1 transmits only the display image G of a screen region for which it is determined that the screen change amount is equal to or less than the threshold value Rs to the terminal device 2, and does not transmit the display image G of a screen region for which it is determined that the screen change amount exceeds the threshold value Rs to the terminal device 2.

With such a configuration, the screen intended by the presenter (a screen that is being described) can be displayed on the terminal device 2 in the same manner for each divided screen.

Although an embodiment of the present invention has been described above in detail with reference to the drawings, a specific configuration is not limited to this embodiment, and includes designs and the like within a range not departing from the gist of the present invention.

### INDUSTRIAL APPLICABILITY

According to the above image display device, if the display image G is displayed on the terminal device via the network, the display delay on the terminal device can be suppressed

### DESCRIPTIONS OF REFERENCES

1 Image display device

2 Terminal device

11 Communication device

12 Data processing device

13 Storage device

14 Image output device

What is claimed is:

1. An image display device, comprising:
a data processing device configured to stop transmission of a display image displayed on a display screen to a terminal device if the amount of change of the display screen exceeds a first threshold value.

2. The image display device according to claim 1, wherein the data processing device is configured to stop transmission of the display image to the terminal device, and then start transmission of the display image if the amount of change becomes equal to or less than a second threshold value after the transmission of the display image is stopped.

3. The image display device according to claim 2, wherein, the data processing device is configured to set the second threshold value to be a higher value if a moving image is included in at least a part of the display image, than if the moving image is not included in the display image.

4. The image display device according to claim 2, wherein the first threshold value is smaller than the second threshold value.

5. The image display device according to claim 2, wherein the data processing device is configured to start transmission of the display image if an elapsed time since transmission of the display image to the terminal device was stopped exceeds a predetermined time and further if the amount of change is equal to or less than the second threshold value.

6. The image display device according to claim 5,
wherein the data processing device is conjured to acquire the display image by capturing the display screen at a predetermined cycle, and
the predetermined time is larger than the predetermined cycle.

7. The image display device according to claim 1, wherein the data processing device is configured to set the first threshold value such that the first threshold value becomes smaller as the number of terminal devices connected to the image display device via a network increases.

8. The image display device according to claim 1, wherein the data processing device sets the first threshold value according to the number of terminal devices connected to the image display device via a network.

9. The image display device according to claim 1, wherein, if the display image is transmitted to the terminal device, the data processing device stop the transmission of the display image and discard the display image if the amount of change exceeds the first threshold value.

10. An image transmission method, comprising:
stopping transmission of a display image displayed on a display screen to a terminal device if the amount of change of the display screen exceeds a first threshold value.
